(19) United States
(12) Patent Application Publication
(10) Pub. No.: US 2026/0093274 A1
(43) Pub. Date: Apr. 2, 2026

(54) MAPPING CORRECTION METHOD AND RELATED APPARATUS

(71) Applicant: SHENZHEN MAMMOTION INNOVATION CO., LIMITED, Shenzhen (CN)

(72) Inventors: Jidong WEI, Shenzhen (CN); Pengju DU, Shenzhen (CN); Kai WANG, Shenzhen (CN); Jianlin CHEN, Shenzhen (CN); Dengqiang TONG, Shenzhen (CN)

(21) Appl. No.: 19/411,297

(22) Filed: Dec. 7, 2025

Related U.S. Application Data
(63) Continuation-in-part of application No. PCT/CN2023/099063, filed on Jun. 8, 2023.

(51) Int. Cl. G05D 1/80; A01D 34/00; A01D 101/00; G05D 1/246; G05D 105/15; G05D 105/80; G05D 107/20

(52) U.S. Cl. CPC G05D 1/80; A01D 34/008; G05D 1/246; A01D 2101/00; G05D 2105/15; G05D 2105/87; G05D 2107/23

(57) ABSTRACT

Disclosed in the embodiments of the present application are a mapping correction method and a related apparatus, which are applied to a mower. The method comprises: receiving, in response to an error occurring in a mapping trajectory of the lawn mowing robot, a correction instruction; determining a target correction point in the mapping trajectory while the lawn mowing robot is moving, the target correction point being located at a distance greater than a predetermined distance from a start point of the mapping trajectory; and returning to the target correction point, and continuing a mapping operation based on a correct mapping trajectory and the target correction point, the correct mapping trajectory being a portion of the mapping trajectory between the start point and the target correction point.

### CROSS REFERENCE TO RELATED APPLICATIONS

This disclosure is a Continuation-in-Part of International Disclosure No. PCT/CN2023/099063, filed on Jun. 8, 2023, with the disclosure name “Mapping correction method and related apparatus,” the entire disclosures of which are incorporated by reference in this disclosure by reference.

### TECHNICAL FIELD

The present disclosure relates to the field of robotics, and in particular to a mapping correction method and related apparatus.

### BACKGROUND

Before autonomous operation, a lawn mowing robot typically performs initial mapping for work map. The robot's operation path is planned based on map information. In initial mapping, a human traces the work map boundary. Due to various reasons (such as human error), the traced work map boundary may deviate from the intended boundary, requiring part of the initially traced boundary to be removed and re-traced at the correct location until the boundary is closed, at which point initial mapping is complete. In practice, once such a situation occurs, mapping must be restarted from the beginning; returning the lawn mowing robot to the mapping start point and rebuilding, which lowers mapping efficiency. Therefore, there is a need to improve mapping efficiency when error occurs.

### SUMMARY

The embodiments of the present disclosure provide a method for correction mapping and related apparatus, which can improve mapping efficiency when an error occurs the mapping process.

According to a first aspect □ an embodiment of the present disclosure provides a mapping correction method, performed by a lawn mowing robot, comprising:
receiving, in response to an error occurring in a mapping trajectory of the lawn mowing robot, a correction instruction.
determining a target correction point in the mapping trajectory while the lawn mowing robot is moving, the target correction point being located at a distance greater than a predetermined distance from a start point of the mapping trajectory;
returning to the target correction point, and continuing a mapping operation based on a correct mapping trajectory and the target correction point, the correct mapping trajectory being a portion of the mapping trajectory between the start point and the target correction point.

According to a second aspect, an embodiment of the present disclosure provides a mapping correction method, applied to a display device, the method comprising:
issuing, in response to an error occurring in a mapping trajectory of a lawn mowing robot, a correction instruction;
controlling the lawn mowing robot to move and, determining a target correction point in the mapping trajectory while the lawn mowing robot is moving, the target correction point being located at a distance greater than a predetermined distance from a start point of the mapping trajectory; and
controlling the lawn mowing robot to return to the target correction point, and continuing a mapping operation based on a correct mapping trajectory and the target correction point, the correct mapping trajectory being a portion of the mapping trajectory between the start point and the target correction point;

According to the third aspect, an embodiment of the present disclosure provides a mapping correction device, applied to a lawn mowing robot, the device comprising: a receiving unit, a determining unit, and a mapping unit, wherein:
the receiving unit is configured to receive a correction instruction when an error occurs in the mapping trajectory of the lawn mowing robot;
the determining unit is configured to determine a target correction point in the mapping trajectory during movement, the target correction point being at a distance from the start point of the mapping trajectory that is greater than a set distance;
the mapping unit is configured to return to the target correction point and continue mapping based on a correct mapping trajectory and the target correction point, the correct mapping trajectory being the portion of the mapping trajectory between the start point and the target correction point.

According to the fourth aspect, some embodiments of the present disclosure provides a mapping correction device, applied to a display device, the device comprising: an issuing unit, a determining unit, and a mapping unit, wherein:
the issuing unit is configured to issue a correction instruction when an error occurs in the mapping trajectory of the lawn mowing robot;
the determining unit is configured to control the lawn mowing robot to move, and during movement, determine a target correction point in the mapping trajectory, the target correction point being at a distance from the start point of the mapping trajectory that is greater than a set distance;
the mapping unit is configured to control the lawn mowing robot to return to the target correction point and continue mapping based on a correct mapping trajectory and the target correction point, the correct mapping trajectory being the portion of the mapping trajectory between the start point and the target correction point.

According to the fifth aspect, an embodiment of the present disclosure provides a lawn mowing robot, comprising a processor, a memory, a communication interface, and one or more programs, wherein the one or more programs are stored in the memory and configured to be executed by the processor, the program(s) including instructions for performing the steps of the first aspect of the present disclosure.

According to the sixth aspect, an embodiment of the present disclosure provides a display device, comprising a processor, a memory, a communication interface, and one or more programs, wherein the one or more programs are stored in the memory and configured to be executed by the processor, the program(s) including instructions for performing the steps of the second aspect of the present disclosure.

According to the seventh aspect, an embodiment of the present disclosure provides a computer-readable storage medium, wherein the computer-readable storage medium stores a computer program for electronic data exchange, wherein the computer program causes the computer to execute some or all of the steps of the method described in the first aspect of the present disclosure.

According to the eighth aspect, an embodiments of the present disclosure provides a computer-readable storage medium, wherein the computer-readable storage medium stores a computer program for electronic data exchange, wherein the computer program causes the computer to execute some or all of the steps of the method described in the second aspect of the present disclosure.

According to the ninth aspect, an embodiment of the present disclosure provides a computer program product, wherein the computer program product includes a non-transitory computer-readable storage medium storing a computer program, wherein the computer program is operable to cause the computer to perform some or all of the steps described in the first aspect of the present disclosure. The computer program product may be a software installation package.

According to the tenth aspect, an embodiment of the present disclosure provides a computer program product, wherein the computer program product includes a non-transitory computer-readable storage medium storing a computer program, wherein the computer program is operable to cause the computer to perform some or all of the steps described in the second aspect of the present disclosure. The computer program product may be a software installation package.

### BRIEF DESCRIPTION OF THE DRAWINGS

In order to more clearly illustrate the technical solutions of the embodiments of the present disclosure or the prior art, the following is a brief introduction to the drawings used in the description of the embodiments or prior art. It is evident that the drawings described below are merely some embodiments of the present disclosure. For those skilled in the art, without requiring any creative effort, other drawings can also be derived based on these drawings.

FIG. 1A is a schematic flow diagram of a mapping correction method

FIG. 1B is a schematic illustration of one mapping trajectory.

FIG. 1C is a schematic illustration of another mapping trajectory.

FIG. 1D is a schematic illustration of yet another mapping trajectory.

FIG. 1E is a schematic illustration of still another mapping trajectory.

FIG. 2 is a schematic flow diagram of another mapping correction method.

FIG. 3 is a schematic flow diagram of another mapping correction method.

FIG. 4 is a schematic flow diagram of another mapping correction method.

FIG. 5 is a schematic structural diagram of an electronic device.

FIG. 6 is a functional block diagram of a mapping correction apparatus 600.

FIG. 7 is a functional block diagram of a mapping correction apparatus 700.

### DETAILED DESCRIPTION

In order to help those skilled in the art better understand the solutions of the present disclosure, the technical solutions in the embodiments of the present disclosure will be described clearly and completely below in conjunction with the drawings in the embodiments of the present disclosure. It is obvious that the described embodiments are merely a portion of the embodiments of the present disclosure, not all of the embodiments. All other embodiments derived by those skilled in the art, without any creative effort, based on the embodiments of the present disclosure, fall within the scope of protection of the present disclosure.

The terms ‘first’, ‘second’, etc., in the specification, claims, and the drawings above are used to distinguish different objects and are not intended to describe a specific order. Additionally, the terms ‘include’ and ‘have’, as well as any variations thereof, are intended to cover non-exclusive inclusion. For example, a process, method, system, product, or apparatus that includes a series of steps or units is not limited to the steps or units listed but may optionally include other steps or units not listed or other steps or units inherent to these processes, methods, products, or devices.

The term ‘embodiment’ as used herein means that a specific feature, structure, or characteristic described in conjunction with an embodiment can be included in at least one embodiment of the present disclosure. The phrase appearing at various locations in the specification does not necessarily refer to the same embodiment nor is it exclusive or alternative to other embodiments. What those skilled in the art will understand explicitly and implicitly is that the embodiments described herein can be combined with other embodiments.

In the embodiments of the present disclosure, the electronic device may include a lawn mowing robot or a display device. The display device may include any device with display functionality, such as a smartphone (e.g., Android phone, iOS phone, Windows Phone), tablet computer, handheld computer, dash camera, server, notebook computer, mobile internet device (MID), or wearable device (e.g., smartwatches, Bluetooth headsets). These are merely examples and not exhaustive; the display device includes but is not limited to the above.

In the embodiments of the present disclosure, the mapping trajectory of the lawn mowing robot may be understood as follows: during the movement of the lawn mowing robot, positioning operations may be performed at regular or irregular intervals. Each positioning location may be treated as a waypoint, and connecting these positioning locations together forms the mapping trajectory.

In the embodiments of the present disclosure, the lawn mowing robot and the display device may exist independently, and a communication connection can be established between the lawn mowing robot and the display device. The display device can be used to control the lawn mowing robot, and the mapping trajectory of the lawn mowing robot can also be displayed on the display device.

Detailed description of the embodiments of the present disclosure:

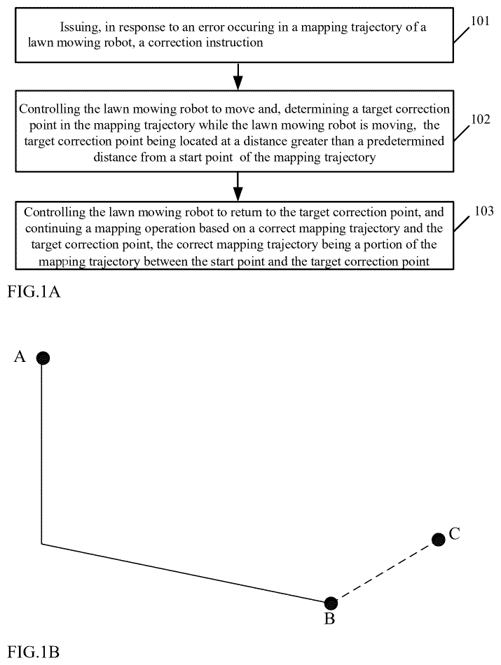

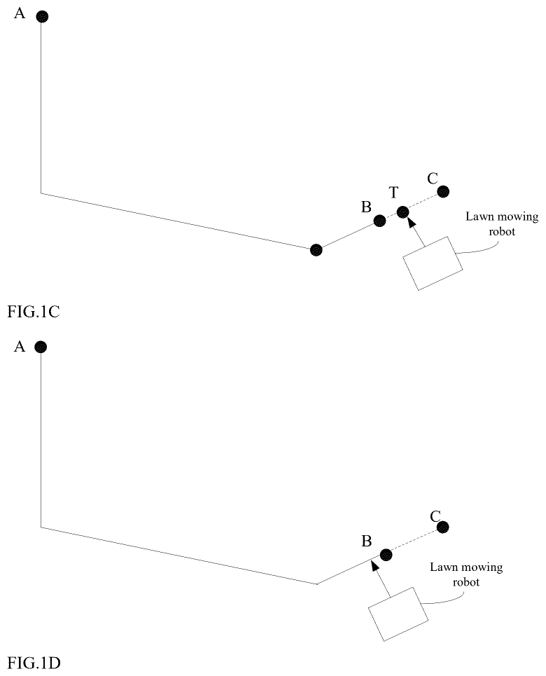

Refer to FIG. 1A, which is a flowchart of a mapping correction method according to an embodiment of the present disclosure, applied to an electronic device. As shown, this map correction method includes:
Step 101. Issuing, in response to an error occurring in a mapping trajectory of the lawn mowing robot, a correction instruction.

In some embodiments of the present disclosure, the electronic device may include a lawn mowing robot or a display device.

In a specific implementation, the lawn mowing robot can perform positioning at preset time intervals, designating each positioning location as a waypoint. Assuming that N waypoints are obtained, where N is a positive integer, the start point of the lawn mowing robot, the N waypoints, and the current position point together form the mapping trajectory. The preset time interval may be pre-set or system-default.

In a specific implementation, the electronic device may use indoor positioning technology (such as Wi-Fi positioning), satellite positioning technology, etc., for positioning operations.

In a specific implementation, when an error occurs in the mapping trajectory of the lawn mowing robot, the electronic device may automatically issue the correction instruction, or the correction instruction may be issued manually. The correction instruction serves to prompt the user to correct the mapping trajectory or may automatically correct the trajectory.

In some embodiments of the present disclosure, when the positioning signal of the lawn mowing robot weakens or the robot enters a specific area (e.g., an area with many obstacles), the system can detect whether an error has occurred in the mapping trajectory. The specific area can be pre-set or system-default, enabling the system to adapt to complex mapping scenarios, such as poor positioning signals or the robot encountering difficulties.

In a specific implementation, when an error occurs in the mapping trajectory between at least one of the N waypoints and the current position point, a trajectory clipping method can be adopted to determine the correct mapping trajectory between the N waypoints and the current position point.

Optionally, the method may include the following steps:
A1. Detect the position parameters of the lawn mowing robot, which include at least one of the following: signal strength, position coordinates;
A2. When the position parameters satisfy a set condition, determine that an error has occurred in the mapping trajectory of the lawn mowing robot.

The position parameters can include signal strength, position coordinates, etc., without limitation. The signal strength refers to the positioning signal strength at a specific location, and position coordinates refer to the coordinates obtained when the lawn mowing robot is positioned.

The set conditions can be pre-set or system-default, for example, the set condition could be when the signal strength is less than a pre-set threshold, or when the position coordinates fall within a pre-set area or are within a pre-set distance from the area.

In some embodiments of the present disclosure, the electronic device can detect the position parameters of the lawn mowing robot, and when the position parameters meet the set conditions, it can indicate that there is an error in the mapping trajectory. The system can then issue a warning message to prompt the user to confirm whether there is indeed an error in the mapping. If the position parameters do not meet the set conditions, it indicates that the mapping trajectory is correct, and the mapping can continue.

In a specific implementation, the signal strength along the mapping path can be evaluated, and when poor signal strength is detected, the user can be prompted to correct the trajectory, enabling quick error response and reducing the need for re-building the map.

In a specific implementation, using real-time kinematic (RTK) positioning technology as an example, errors in the map creation trajectory can occur in several scenarios:

First, when RTK positioning is good, and the user notices an error in the map boundary, the user can switch to a modification state. At this time, the direction arrow on the display device points directly from the lawn mowing robot to the map boundary, and the user can customize the return path. Once the lawn mowing robot deviates from the mapping trajectory, the normal line formed by the arrow continuously points to the nearest point on the trajectory.

Second, when poor positioning occurs, the user notices an obstruction above the robot and can manually control the robot to return to the unobstructed portion of the mapping trajectory to modify the map boundary. Typically, the RTK on the robot is in a floating state, and a normal line appears when the user edits the map boundary.

Third, the lawn mowing robot proactively identifies an error based on RTK positioning signals. In this case, the error might not be a true boundary error but could be caused by poor satellite positioning in a specific area. The signal strength at recorded positioning points can be color-mapped on the display device, allowing the user to intuitively return to the part of the mapping trajectory with good signal strength to continue the mapping process.
Step 102. Controlling the lawn mowing robot to move and, determining a target correction point in the mapping trajectory while the lawn mowing robot is moving, the target correction point being located at a distance greater than a predetermined distance from a start point of the mapping trajectory.

In some embodiments of the present disclosure, the electronic device can automatically select the target correction point from the mapping trajectory, or the user can manually select the target correction point from the trajectory. The target correction point is a point on the mapping trajectory.

The set distance can be pre-set or system-default. For example, the set distance could be 0.3 meters. In a specific implementation, the target correction point is located at a distance from the start point of the mapping trajectory that is greater than the set distance, ensuring that the lawn mowing robot does not return to the start point of the trajectory when an error occurs.

Optionally, in step 102, determining the target correction point in the mapping trajectory during movement can include the following steps:
A21. generating, based on a current position point of the lawn mowing robot, at least one connecting line to the mapping trajectory, each connecting line forming an intersection point with the mapping trajectory.
A22. Determining, for each connecting line, a distance between the corresponding intersection point and the current position point to obtain at least one distance value.
A23. Selecting a target distance value from the at least one distance value, acquiring the intersection point corresponding to the target distance value, and designating the intersection point as the target correction point.

In some embodiments of the present disclosure, the mapping trajectory can be connected to the previous position of the lawn mowing robot, forming at least one line, each of which intersects with the correct mapping trajectory. Then, the distance between the intersection points and the current position is calculated to obtain distance values. The target distance value can be selected from these values, for example, selecting the minimum value as the target distance value, or selecting the maximum value as the target distance value, and the corresponding intersection point will be selected as the target correction point.

Optionally, when the electronic device is a display device, step 103 can include the following steps:
B31. When the distance between the lawn mowing robot and the mapping trajectory is less than a preset distance, enlarge the mapping trajectory to a specified magnification;
B32. Select any point on the enlarged mapping trajectory as the target correction point.

The specified magnification and the preset distance can be pre-set or system-default.

In some embodiments of the present disclosure, when selecting the correction position, the display interface of the display device can be appropriately zoomed in, so that the user can more accurately select the target correction point and control the lawn mowing robot to reach the target correction point.

In a specific implementation, when the electronic device is a display device, if the distance between the lawn mowing robot and the mapping trajectory is smaller than a preset distance, the correct mapping trajectory on the display interface can be enlarged to a specified magnification. The user can then select any position point (waypoint) on the enlarged correct mapping trajectory as the target correction point. This improves the efficiency and accuracy of the user in selecting the correction point. By interacting through the display interface, errors can be detected promptly, and the user can visualize and reconstruct the corrections, reducing the difficulty of re-building and enhancing the user experience.

Optionally, when the electronic device is a display device, step 103 can include the following steps:
C31. Determine the signal strength values of the waypoints in the mapping trajectory that meet the preset conditions, obtaining P signal strength values;
C32. Select the signal strength values among the P values that are greater than a set threshold, obtaining Q signal strength values;
C33. Select any of the waypoints corresponding to the Q signal strength values as the target correction point.

The preset threshold can be pre-set or system-default. The preset conditions can also be pre-set or system-default, for example, the preset conditions can include waypoints whose positioning time falls within a specified time window, or waypoints that are not located within a specified area, or waypoints whose distance from the current position point is greater than a specified threshold. The specified time window, specified area, and specified threshold can all be pre-set or system-default. For example, in specific implementations, positioning has a certain delay, so waypoints within a certain time period can be selected to ensure the stability of the signal strength value. The signal strength variation within a time period is relatively stable.

In some embodiments of the present disclosure, the display device can recommend points with accurate signal positions on the completed mapping trajectory to the user as reference points when editing the correction mapping trajectory. These reference points can be highlighted on the display interface.

In a specific implementation, the signal strength values of the waypoints that meet the preset conditions in the correct mapping trajectory can be determined, obtaining P signal strength values. Then, the signal strength values among the P values that are greater than the set threshold can be selected, obtaining Q signal strength values. The greater the signal strength, the higher the positioning accuracy and the correctness of the mapping. Any waypoint corresponding to one of the Q signal strength values can be selected as the target correction point, ensuring the correctness of the mapping.
Step 103. Control the lawn mowing robot to return to the target correction point, and continue the mapping operation based on the correct mapping trajectory and the target correction point. The correct mapping trajectory being a portion of the mapping trajectory between the start point and the target correction point.

In some embodiments of the present disclosure, the electronic device can control the lawn mowing robot to return to the target correction point. Specifically, when the electronic device is the lawn mowing robot, it can directly control itself to return to the target correction point. When the electronic device is a display device, the user can issue a one-click command to reach the specified correction point, or remotely control the lawn mowing robot to reach the specified correction point. In this way, when errors occur in the map, corrections can be quickly and efficiently re-built.

In some embodiments of the present disclosure, the mapping correction method can also be applied to set the boundary of a restricted area within the operational lawn, meaning it can be used in fields where boundary setting by the user is needed for robots.

In a specific implementation, when the electronic device is a display device, it can determine the strength of the lawn mowing robot's signal during mapping. Based on the signal strength, the robot can actively rotate and return to the correction position or can be manually controlled to return to the target correction point.

In related technologies, when an error occurs during mapping, it is typically necessary to restart the mapping, which is inefficient. Additionally, in automatic return solutions, there are often unresolvable factors, such as the lawn mowing robot entering areas with no satellite positioning signals due to an error in the tracking path, or entering areas where returning is not possible. Alternatively, the original return path may have many obstacles, creating significant safety risks. This further reduces mapping efficiency. However, in some embodiments of the present disclosure, when an error occurs in the mapping, there is no need to return to the start point. Instead, a point on the correct mapping trajectory is selected as the correction point, thus ensuring the correctness of the map and avoiding the safety risks associated with returning along the original path.

Optionally, step 103, controlling the lawn mowing robot to return to the target correction point, can include the following steps:
step 31. determine the trajectory path between the current position point of the lawn mowing robot and the target correction point;
step 32. detect the dwell time of the lawn mowing robot along the trajectory path;
step 33. when the dwell time at a position i on the trajectory path exceeds a preset value, prompt the user to manually control the lawn mowing robot to return to the target correction point, where i represents any position point on the trajectory path. The preset value can be pre-set or system-default.

In a specific implementation, the trajectory path between the current position point and the target correction point can be determined, and the dwell time of the lawn mowing robot along this path can be detected. For example, if the dwell time at position i on the trajectory path exceeds the preset value, the user will be prompted to manually control the lawn mowing robot back to the target correction point.

In specific implementations, during the robot's active return process, if the dwell time at any point exceeds the preset value, or if other sensors detect that the robot is stuck, the user will be prompted to manually control the robot to return to the target correction point.

Optionally, the following step can also be included: retain the correct mapping trajectory and erase the incorrect mapping trajectories.

In some embodiments of the present disclosure, before controlling the lawn mowing robot to return to the target correction point, the mapping trajectory between the target correction point and the erroneous position can be erased. Alternatively, after controlling the robot to return to the target correction point, the mapping trajectory between the target correction point and the erroneous position can be erased, so only the correct mapping trajectory is retained, and the other mapping trajectories are erased.

In specific implementations, when the electronic device is a display device, valid locations (target correction points) can be selected for return operations, avoiding situations where unresolvable factors occur in the automatic return solution, and improving the efficiency of the lawn mowing robot's return.

In specific implementations, after an error occurs in the mapping, the efficient correction solution in the present embodiment can be adopted, which not only adapts to complex terrain conditions but also enhances safety.

For example, as shown in FIG. 1B, assuming the initial mapping point of the lawn mowing robot is point A, and the robot passes through point B and finally reaches point C during the mapping process. When an error occurs between points B and C, the robot can be controlled to return to point B to re-create the map, without needing to return to the initial point A. Instead, a point on the correct mapping trajectory can be selected as the correction point, thus improving efficiency.

For another example, as shown in FIG. 1C, point T in the diagram can be a perpendicular point. The lawn mowing robot tracks the mapping under user control, and the positioning information is transmitted in real time to the display device. On the display device, the signal strength is converted into different colors to prompt the user. When the user observes a color change in a specific segment of the mapping, the user can rebuild the mapping trajectory for that segment. For example, in some areas with obstructions, the lawn mowing robot may have fewer satellites and poor positioning accuracy. Through this prompt, the user can be effectively alerted to improve the boundary or restricted area accuracy, thus ensuring the correctness of the map and enhancing the efficiency of the lawn mowing robot.

For another example, as shown in FIG. 1C to FIG. 1E, assuming the initial mapping point of the lawn mowing robot is point A, the robot passes through point B and finally reaches point C, and the error occurs at point B (or any other location). The user can control the robot to return to point B. While controlling the robot's movement, the robot's center position can extend a dashed line, which intersects with the normal of the mapping trajectory (i.e., finding the closest point on the mapping trajectory). For example, as shown in FIG. 1E, B1 and B2 are perpendicular points. When the robot is inside the mapping trajectory, there will be two normal lines. At this time, L1<L2, so the robot will display the dashed line L1. It should be noted that the dashed line does not necessarily point to the extended line of the tracking path. When the robot is inside the mapping trajectory and there are multiple normal dashed lines pointing to the mapping trajectory, the user can also select one of the dashed lines through the display interface to determine the correct correction point.

In a specific implementation, as shown in FIG. 1D, the mapping correction process is described. When the user notices that the mapping trajectory differs from the actual lawn boundary that needs to be worked on, the user can issue a command through the display interface of the display device to start the mapping correction process. The user controls the lawn mowing robot to move backward, and the robot uses its sensors to locate its current position, which is displayed in real-time on the display device. The normal dashed line is also displayed on the device to indicate to the user the current position where the robot can re-create the map. Alternatively, the correct re-creation position can be displayed in different colors (such as red, gray, etc.) on the display device, which helps improve the identification of the mapping trajectory.

In a specific implementation, when the desired re-creation correction path is reached, the user can control the lawn mowing robot to follow the dashed line to the specified position (target correction point). It should be noted that the user can either issue a one-click command to reach the target correction position or remotely control the robot to reach the target correction position.

When the lawn mowing robot reaches the target position, it receives a continue mapping signal. The incorrect mapping trajectory information for the B-C segment is erased, and the robot then continues with the new mapping trajectory until the mapping is complete.

Furthermore, the continue mapping signal can be issued by the user or based on preset conditions. For example, when the robot reaches the target correction point B, a continue mapping signal can be issued, or the signal can be automatically triggered when the robot is within a preset distance, fitting the actual position of the robot to the position of point B.

The mapping correction method described in the present disclosure, applied to an electronic device, involves issuing a correction instruction when an error occurs in the mapping trajectory of the lawn mowing robot. The robot is controlled to move, and during movement, a target correction point in the mapping trajectory is determined. The target correction point is located at a distance from the start point of the trajectory that is greater than a set distance. The robot then returns to the target correction point and continues the mapping operation based on a correct mapping trajectory and the target correction point. The correct mapping trajectory is the portion of the trajectory between the start point and the target correction point. Thus, when an error occurs in the mapping, there is no need to return to the start point; instead, a point on the correct mapping trajectory is selected as the correction point, thereby ensuring the correctness of the map and avoiding the safety risks associated with returning along the original path.

Refer to FIG. 2, which is a flowchart of another map correction method according to an embodiment of the present disclosure, applied to an electronic device. As shown, this map correction method includes:
Step 201. Issuing, in response to an error occurring in a mapping trajectory of the lawn mowing robot, a correction instruction.
Step 202. Controlling the lawn mowing robot to move and determining a target correction point in the mapping trajectory while the lawn mowing robot is moving, the target correction point being located at a distance greater than a predetermined distance from a start point of the mapping trajectory.
Step 203. control the lawn mowing robot to return to the target correction point and continue the mapping operation based on the correct mapping trajectory and the target correction point. The correct mapping trajectory being a portion of the mapping trajectory between the start point and the target correction point.

The detailed description of steps 201 to 203 can refer to the corresponding steps in the mapping correction method described in FIG. 1A, and will not be repeated here.

The mapping correction method described in the present disclosure, applied to an electronic device, issues a correction instruction when an error occurs in the mapping trajectory of the lawn mowing robot. The robot is controlled to move, and during movement, the target correction point in the mapping trajectory is determined, where the target correction point is located at a distance from the start point of the mapping trajectory that is greater than the set distance. The robot then returns to the target correction point and continues the mapping operation based on the correct mapping trajectory and the target correction point. The correct mapping trajectory is the portion of the trajectory between the start point and the target correction point. Thus, when an error occurs in the mapping, there is no need to return to the start point; instead, a point on the correct mapping trajectory is selected as the correction point, thereby ensuring the correctness of the map and avoiding the safety risks associated with returning along the original path.

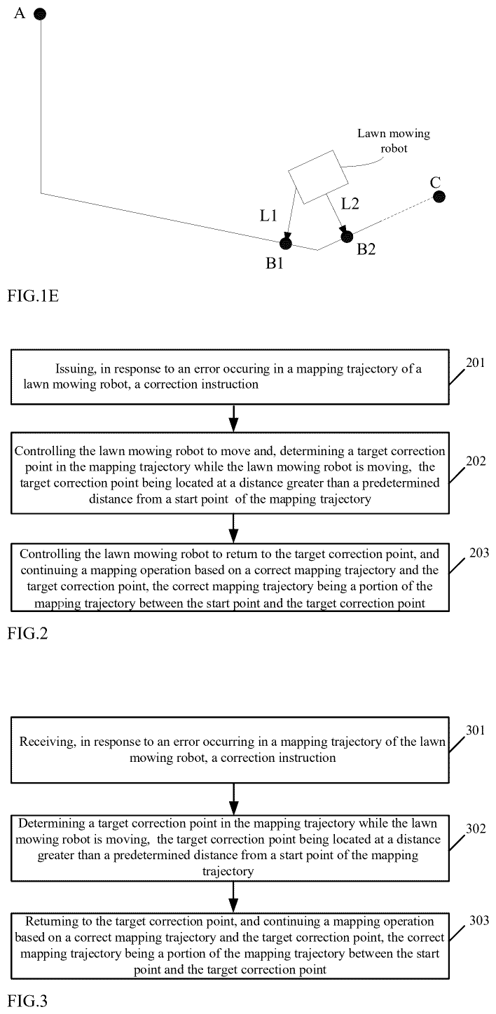

Refer to FIG. 3, which is a flowchart of another map correction method according to an embodiment of the present disclosure, applied to the lawn mowing robot. As shown, this map correction method includes:
step 301. receiving, in response to an error occurring in a mapping trajectory of the lawn mowing robot, a correction instruction.
step 302. determining a target correction point in the mapping trajectory while the lawn mowing robot is moving, the target correction point being located at a distance greater than a predetermined distance from a start point of the mapping trajectory.
step 303. returning to the target correction point, and continuing a mapping operation based on a correct mapping trajectory and the target correction point, the correct mapping trajectory being a portion of the mapping trajectory between the start point and the target correction point.

The detailed description of steps 301 to 303 can refer to the corresponding steps in the mapping correction method described in FIG. 1A, and will not be repeated here.

The mapping correction method described in the present disclosure, applied to the lawn mowing robot, issues a correction instruction when an error occurs in the mapping trajectory. The robot is controlled to move, and during movement, the target correction point in the mapping trajectory is determined. The target correction point is located at a distance from the start point of the mapping trajectory that is greater than the set distance. The robot then returns to the target correction point and continues the mapping operation based on the correct mapping trajectory and the target correction point. The correct mapping trajectory is the portion of the trajectory between the start point and the target correction point. Thus, when an error occurs in the mapping, there is no need to return to the start point; instead, a point on the correct mapping trajectory is selected as the correction point, ensuring the correctness of the map and avoiding the safety risks associated with returning along the original path.

Refer to FIG. 4, which is a flowchart of another map correction method according to an embodiment of the present disclosure, applied to a display device. As shown, this map correction method includes:
step 401. Issuing, in response to an error occurring in a mapping trajectory of the lawn mowing robot, a correction instruction.
step 402. Controlling the lawn mowing robot to move and, determining a target correction point in the mapping trajectory while the lawn mowing robot is moving, the target correction point being located at a distance greater than a predetermined distance from a start point of the mapping trajectory.
step 403. Control the lawn mowing robot to return to the target correction point, and continue the mapping operation based on the correct mapping trajectory and the target correction point. The correct mapping trajectory being a portion of the mapping trajectory between the start point and the target correction point. The detailed description of steps 401 to 403 can refer to the corresponding steps in the mapping correction method described in FIG. 1A, and will not be repeated here.

The mapping correction method described in the present disclosure, applied to the display device, issues a correction instruction when an error occurs in the mapping trajectory of the lawn mowing robot. The robot is controlled to move, and during movement, the target correction point in the mapping trajectory is determined, with the target correction point being at a distance from the start point of the mapping trajectory that is greater than the set distance. The robot then returns to the target correction point and continues the mapping operation based on the correct mapping trajectory and the target correction point. The correct mapping trajectory is the portion of the trajectory between the start point and the target correction point. Thus, when an error occurs in the mapping, there is no need to return to the start point; instead, a point on the correct mapping trajectory is selected as the correction point, ensuring the correctness of the map and avoiding the safety risks associated with returning along the original path.

As in the above embodiments, refer to FIG. 5, which is a schematic diagram of the structure of an electronic device according to an embodiment of the present disclosure. As shown, the electronic device includes a processor, a memory, a communication interface, and one or more programs. The one or more programs are stored in the memory and are configured to be executed by the processor. In some embodiments of the present disclosure, the electronic device may include a lawn mowing robot and/or a display device.

Optionally, when the electronic device is a lawn mowing robot, the program includes instructions for executing the following steps:
receive a correction instruction when an error occurs in the mapping trajectory of the lawn mowing robot;
during movement, determine the target correction point in the mapping trajectory, with the target correction point being at a distance from the start point of the mapping trajectory that is greater than the set distance;
return to the target correction point and continue the mapping operation based on the correct mapping trajectory and the target correction point. The correct mapping trajectory is the portion of the trajectory between the start point and the target correction point.

Optionally, in the step of determining the target correction point in the mapping trajectory during movement, the program includes instructions for executing the following steps:
draw a line from the current position of the lawn mowing robot to the mapping trajectory to form at least one line, each line intersecting the mapping trajectory;
for each of the lines, determine the distance between the intersection point and the current position, obtaining at least one distance value;
select a target distance value from the at least one distance value and obtain the intersection point corresponding to the target distance value, designating that intersection point as the target correction point.

Optionally, in the step of controlling the lawn mowing robot to return to the target correction point, the program includes instructions for executing the following steps:
determine the trajectory path between the current position and the target correction point;
detect the dwell time of the lawn mowing robot along the trajectory path;
when the dwell time at any position i on the trajectory path exceeds a preset value, send a prompt to the display device to prompt the user to manually control the lawn mowing robot to return to the target correction point, where i is any position on the trajectory path.

Optionally, the program also includes instructions for executing the following steps: Detect the position parameters of the lawn mowing robot, which include at least one of the following: signal strength, position coordinates;
when the position parameters meet the set conditions, determine that an error has occurred in the mapping trajectory of the lawn mowing robot.

Optionally, when the electronic device is a display device, the program includes instructions for executing the following steps:
when an error occurs in the mapping trajectory of the lawn mowing robot, issue a correction instruction;
control the lawn mowing robot to move, and during movement, determine the target correction point in the mapping trajectory, where the target correction point is located at a distance from the start point of the mapping trajectory that is greater than the set distance;
control the lawn mowing robot to return to the target correction point, and continue the mapping operation based on the correct mapping trajectory and the target correction point. The correct mapping trajectory is the portion of the mapping trajectory between the start point and the target correction point.

Optionally, in the step of determining the target correction point in the mapping trajectory during movement, the program includes instructions for executing the following steps:
draw a line from the current position of the lawn mowing robot to the mapping trajectory, forming at least one line, each line intersecting the mapping trajectory;
for each of the lines, determine the distance between the intersection point and the current position point, obtaining at least one distance value;
select a target distance value from the at least one distance value, and acquire the intersection point corresponding to the target distance value, designating that intersection point as the target correction point.

Optionally, in the step of determining the target correction point in the mapping trajectory during movement, the program includes instructions for executing the following steps:
when the distance between the lawn mowing robot and the mapping trajectory is smaller than a preset distance, enlarge the mapping trajectory to a specified magnification;
select any position point on the enlarged mapping trajectory as the target correction point.

Optionally, in the step of determining the target correction point in the mapping trajectory during movement, the program includes instructions for executing the following steps:
determine the signal strength values of the waypoints in the mapping trajectory that meet the preset conditions, obtaining P signal strength values;
select the signal strength values among the P values that are greater than a set threshold, obtaining Q signal strength values;
select any of the waypoints corresponding to the Q signal strength values as the target correction point.

Optionally, in the step of controlling the lawn mowing robot to return to the target correction point, the program includes instructions for executing the following steps:
determine the trajectory path between the current position and the target correction point;
detect the dwell time of the lawn mowing robot along the trajectory path;
when the dwell time at any position i on the trajectory path exceeds a preset value, prompt the user to manually control the lawn mowing robot to return to the target correction point, where i is any position on the trajectory path.

Optionally, the program also includes instructions for executing the following steps:
detect the position parameters of the lawn mowing robot, which include at least one of the following: signal strength, position coordinates;
when the position parameters meet the set conditions, determine that an error has occurred in the mapping trajectory of the lawn mowing robot.

Optionally, the program also includes instructions for executing the following steps:
Retain the correct mapping trajectory and erase the incorrect mapping trajectories.

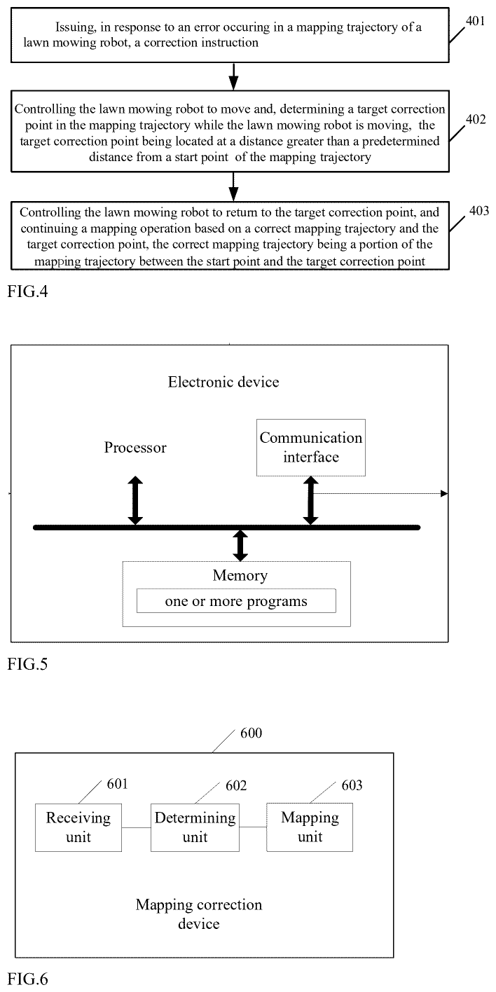

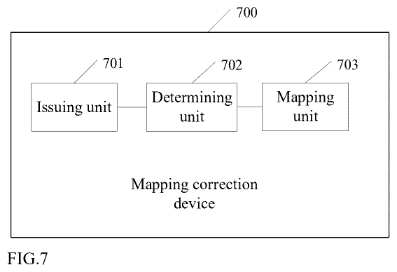

Refer to FIG. 6, which is a functional block diagram of the mapping correction device 600 involved in some embodiments of the present disclosure. The mapping correction device 600 is applied to a lawn mowing robot. The device 600 includes: a receiving unit 601, a determining unit 602, and a mapping unit 603, wherein:
the receiving unit 601 is configured to receive a correction instruction when an error occurs in the mapping trajectory of the lawn mowing robot;
the determining unit 602 is configured to determine the target correction point in the mapping trajectory during movement, where the target correction point is at a distance from the start point of the mapping trajectory that is greater than the set distance;
the mapping unit 603 is configured to return to the target correction point and continue the mapping operation based on the correct mapping trajectory and the target correction point. The correct mapping trajectory is the portion of the mapping trajectory between the start point and the target correction point.

Optionally, in determining the target correction point in the mapping trajectory during movement, the determining unit 602 is specifically configured to:
draw a line from the current position of the lawn mowing robot to the mapping trajectory, forming at least one line, each line intersecting the mapping trajectory;
determine the intersection point of each line with the current position and the distance, obtaining at least one distance value;
select a target distance value from the at least one distance value and acquire the intersection point corresponding to the target distance value, designating that intersection point as the target correction point.

Optionally, in controlling the lawn mowing robot to return to the target correction point, the determining unit 602 is specifically configured to:
determine the trajectory path between the current position point and the target correction point;
detect the dwell time of the lawn mowing robot along the trajectory path;
when the dwell time at position i on the trajectory path exceeds a preset value, send a prompt to the display device to prompt the user to manually control the lawn mowing robot to return to the target correction point, where position i is any position on the trajectory path.

Optionally, the device 600 is also specifically configured to:
Detect the position parameters of the lawn mowing robot, which include at least one of the following: signal strength, position coordinates;
When the position parameters meet the set conditions, determine that an error has occurred in the mapping trajectory of the lawn mowing robot.

The mapping correction device described in the present disclosure, applied to the lawn mowing robot, receives a correction instruction when an error occurs in the mapping trajectory of the lawn mowing robot. The robot is controlled to move, and during movement, the target correction point in the mapping trajectory is determined. The target correction point is located at a distance from the start point of the mapping trajectory that is greater than the set distance. The robot then returns to the target correction point and continues the mapping operation based on the correct mapping trajectory and the target correction point. The correct mapping trajectory is the portion of the trajectory between the start point and the target correction point. Thus, when an error occurs in the mapping, there is no need to return to the start point; instead, a point on the correct mapping trajectory is selected as the correction point, ensuring the correctness of the map and avoiding the safety risks associated with returning along the original path.

It can be understood that the functionalities of the program modules in the mapping correction device of the present embodiment can be implemented according to the method embodiments described above. The specific implementation process can refer to the relevant descriptions in the method embodiments above and will not be repeated here.

Refer to FIG. 7, which is a functional block diagram of another mapping correction device 700 involved in some embodiments of the present disclosure, applied to a display device. The device 700 includes: an issuing unit 701, a determining unit 702, and a mapping unit 703, wherein:
The issuing unit 701 is configured to issue a correction instruction when an error occurs in the mapping trajectory of the lawn mowing robot;
The determining unit 702 is configured to control the lawn mowing robot to move, and during movement, determine the target correction point in the mapping trajectory, where the target correction point is at a distance from the start point of the mapping trajectory that is greater than the set distance;
The mapping unit 703 is configured to control the lawn mowing robot to return to the target correction point and continue the mapping operation based on the correct mapping trajectory and the target correction point. The correct mapping trajectory is the portion of the mapping trajectory between the start point and the target correction point.

Optionally, in determining the target correction point in the mapping trajectory during movement, the determining unit 702 is specifically configured to:
draw a line from the current position of the lawn mowing robot to the mapping trajectory, forming at least one line, each line intersecting the mapping trajectory;
determine the intersection point of each line with the current position and the distance, obtaining at least one distance value;
select a target distance value from the at least one distance value and acquire the intersection point corresponding to the target distance value, designating that intersection point as the target correction point.

Optionally, in determining the target correction point in the mapping trajectory during movement, the determining unit 702 is specifically configured to:
When the distance between the lawn mowing robot and the mapping trajectory is smaller than a preset distance, enlarge the mapping trajectory to a specified magnification;
Select any position point on the enlarged mapping trajectory as the target correction point.

Optionally, in determining the target correction point in the mapping trajectory during movement, the determining unit 702 is specifically configured to:
determine the signal strength values of the waypoints in the mapping trajectory that meet the preset conditions, obtaining P signal strength values;
select the signal strength values among the P values that are greater than a set threshold, obtaining Q signal strength values;
select any of the waypoints corresponding to the Q signal strength values as the target correction point.

Optionally, in controlling the lawn mowing robot to return to the target correction point, the mapping unit 703 is specifically configured to:
determine the trajectory path between the current position point and the target correction point;
detect the dwell time of the lawn mowing robot along the trajectory path;
When the dwell time at position i on the trajectory path exceeds a preset value, send a prompt to the display device to prompt the user to manually control the lawn mowing robot to return to the target correction point, where position i is any position on the trajectory path.

Optionally, the device 700 is also specifically configured to:
detect the position parameters of the lawn mowing robot, which include at least one of the following: signal strength, position coordinates;
when the position parameters meet the set conditions, determine that an error has occurred in the mapping trajectory of the lawn mowing robot.

Optionally, the device 700 is also specifically configured to: retain the correct mapping trajectory and erase the incorrect mapping trajectories.

The mapping correction device described in the present disclosure, applied to the display device, issues a correction instruction when an error occurs in the mapping trajectory of the lawn mowing robot. The robot is controlled to move, and during movement, the target correction point in the mapping trajectory is determined, where the target correction point is at a distance from the start point of the mapping trajectory that is greater than the set distance. The robot then returns to the target correction point and continues the mapping operation based on the correct mapping trajectory and the target correction point. The correct mapping trajectory is the portion of the trajectory between the start point and the target correction point. Thus, when an error occurs in the mapping, there is no need to return to the start point; instead, a point on the correct mapping trajectory is selected as the correction point, ensuring the correctness of the map and avoiding the safety risks associated with returning along the original path.

It can be understood that the functionalities of the program modules in the mapping correction device of the present embodiment can be implemented according to the method embodiments described above. The specific implementation process can refer to the relevant descriptions in the method embodiments above and will not be repeated here.

The embodiments of the present disclosure also provide a computer-readable storage medium, wherein the computer-readable storage medium stores a computer program for electronic data exchange. This computer program enables the computer to execute some or all of the steps of any of the methods described in the method embodiments above. The computer includes an electronic device.

The embodiments of the present disclosure also provide a computer program product, wherein the computer program product includes a non-transitory computer-readable storage medium storing a computer program. This computer program is operable to cause the computer to execute some or all of the steps of any of the methods described in the method embodiments above. The computer program product can be a software installation package, and the computer includes an electronic device.

The embodiments of the present disclosure have the following beneficial effects: The mapping correction method and related apparatus described in the present disclosure, applied to a lawn mowing robot, receives a correction instruction when an error occurs in the mapping trajectory of the lawn mowing robot. During movement, a target correction point in the mapping trajectory is determined, the target correction point being at a distance from the start point of the mapping trajectory that is greater than a set distance. The robot returns to the target correction point and continues mapping based on a correct mapping trajectory and the target correction point, the correct mapping trajectory being the portion of the mapping trajectory between the start point and the target correction point. Thus, when an error occurs in the mapping, there is no need to return to the start point. Instead, a point on the correct mapping trajectory is selected as the correction point, thereby ensuring the correctness of the mapping and avoiding the safety risks associated with returning along the original path.

It should be noted that for the aforementioned method embodiments, for simplicity, they are described as a series of actions. However, those skilled in the art should understand that the present disclosure is not limited to the described sequence of actions, as some steps can be performed in a different order or simultaneously. Furthermore, those skilled in the art should also understand that the embodiments described in the specification are merely preferred embodiments, and the actions and modules involved are not necessarily required for this disclosure.

In the above embodiments, each description of the embodiments focuses on different aspects. Parts not detailed in a particular embodiment can be referred to from the relevant description in other embodiments.

In the several embodiments provided in this disclosure, it should be understood that the disclosed system can be implemented in other ways. For example, the system embodiments described above are merely illustrative. The division of the above units is just one logical division, and actual implementations may involve different divisions. For instance, multiple units or components may be combined or integrated into another system, or some features may be omitted or not executed. Another point is that the coupling or direct coupling or communication connections between the units discussed or displayed may be achieved through some interfaces, systems, or indirect communication connections, which can be electrical or in other forms.

The units described as separate components may or may not be physically separated. Components displayed as units may or may not be physical units, meaning they can be located in one place or distributed across multiple network units. Depending on the actual needs, some or all of the units can be selected to achieve the objectives of the present embodiment.

Moreover, in the various embodiments of this disclosure, the functional units can be integrated into a single processing unit or physically exist as separate units. Two or more units can also be integrated into a single unit. These integrated units can be implemented in hardware form or as software functional units.

If the integrated units are implemented as software functional units and sold or used as independent products, they can be stored in a computer-readable memory. Based on this understanding, the technical solution of the present disclosure, or the contribution made to the prior art, can be embodied in the form of a software product. This computer software product is stored in a memory and includes instructions for enabling a computer device (which can be a personal computer, server, network device, etc.) to execute some or all of the steps of the methods described in the embodiments of the present disclosure. The aforementioned memory includes: USB flash drives, read-only memory (ROM), random-access memory (RAM), mobile hard drives, floppy disks, optical disks, and other media that can store program code.

One of ordinary skill in the art can understand that all or part of the steps in the various methods described in the embodiments above can be executed by a program that instructs the relevant hardware. This program can be stored in a computer-readable storage medium, which includes: flash drives, read-only memory (ROM), random-access memory (RAM), hard disks, or optical disks.

The above embodiments of the present disclosure have been described in detail. The specific examples used herein are intended to illustrate the principles and implementation methods of the present disclosure. The descriptions of the above embodiments are only intended to help understand the methods and core ideas of the present disclosure. At the same time, for those skilled in the art, modifications in specific implementations and disclosure scopes based on the ideas of the present disclosure will be made. Therefore, the contents of this specification should not be understood as limiting the present disclosure.

What is claimed is:

1. A mapping correction method, performed by a lawn mowing robot, comprising:
receiving, in response to an error occurring in a mapping trajectory of the lawn mowing robot, a correction instruction;
determining a target correction point in the mapping trajectory while the lawn mowing robot is moving, the target correction point being located at a distance greater than a predetermined distance from a start point of the mapping trajectory; and
returning to the target correction point, and continuing a mapping operation based on a correct mapping trajectory and the target correction point, the correct mapping trajectory being a portion of the mapping trajectory between the start point and the target correction point;
wherein the determining the target correction point while the lawn mowing robot is moving comprises:
generating, based on a current position point of the lawn mowing robot, at least one connecting line to the mapping trajectory, each connecting line forming an intersection point with the mapping trajectory;
determining, for each connecting line, a distance between the corresponding intersection point and the current position point to obtain at least one distance value; and
selecting a target distance value from the at least one distance value, acquiring the intersection point corresponding to the target distance value, and designating the intersection point as the target correction point.

2. The mapping correction method according to claim 1, wherein the at least one connecting line comprise a perpendicular line or a line extending between the current position point and any point on the mapping trajectory.

3. The mapping correction method according to claim 1, wherein the returning to the target correction point comprises:
determining a trajectory path between the current position point and the target correction point;
detecting a dwell time of the lawn mowing robot at positions along the trajectory path; and
when a dwell time at a position on the trajectory path exceeds a preset value, transmitting a prompt message to a display device to prompt a user to manually control the lawn mowing robot to return to the target correction point, the position being any position point on the trajectory path.

4. The mapping correction method according to claim 1, further comprising:
detecting a position parameter of the lawn mowing robot, the position parameter comprising at least of: a position signal strength and a position coordinate; and
determining that the mapping trajectory of the lawn mowing robot has the error when the position parameters satisfy a predetermined condition.

5. A mapping correction method, performed by a display device, comprising:
issuing, in response to an error occurring in a mapping trajectory of a lawn mowing robot, a correction instruction;
controlling the lawn mowing robot to move, determining a target correction point in the mapping trajectory while the lawn mowing robot is moving, the target correction point being located at a distance greater than a predetermined distance from a start point of the mapping trajectory; and
controlling the lawn mowing robot to return to the target correction point, and continuing a mapping operation based on a correct mapping trajectory and the target correction point, the correct mapping trajectory being a portion of the mapping trajectory between the start point and the target correction point□wherein the determining the target correction point while the lawn mowing robot is moving comprises:
generating, based on a current position point of the lawn mowing robot, at least one connecting line to the mapping trajectory, each line forming an intersection point with the mapping trajectory;
determining, for each connecting line, a distance between the corresponding intersection point and the current position point to obtain at least one distance value; and
selecting a target distance value from the at least one distance value, acquiring the intersection point corresponding to the target distance value, and designating the intersection point as the target correction point.

6. The mapping correction method according to claim 5, wherein the determining the target correction point while the lawn mowing robot is moving comprises:
when a distance between the lawn mowing robot and the mapping trajectory is less than a preset distance, enlarging the mapping trajectory to a specified magnification; and
selecting a position point on the enlarged mapping trajectory as the target correction point.

7. The mapping correction method according to claim 5, the determining the target correction point while the lawn mowing robot is moving comprises:
determining signal strength values of waypoints in the mapping trajectory that satisfy preset conditions to obtain P signal strength values;
selecting, from the P signal strength values, those greater than a preset threshold to obtain Q signal strength values; and
using a waypoint corresponding to any one of the Q signal strength values as the target correction point.

8. The mapping correction method according to claim 5, wherein the determining the target correction point while the lawn mowing robot is moving comprises:
determining, within a certain time period, signal strength values of waypoints in the mapping trajectory that are greater than a preset threshold; and
selecting, as the target correction point, a middle waypoint of the waypoints within the certain time period.

9. The mapping correction method according to claim 5, wherein controlling the lawn mowing robot to return to the target correction point comprises:
determining a trajectory path between the current position point and the target correction point;
detecting a dwell time of the lawn mowing robot along the trajectory path; and
when the dwell time at a position on the trajectory path exceeds a preset value, prompting a user to manually control the lawn mowing robot to return to the target correction point, the position being any position point on the trajectory path.

10. The mapping correction method according to claim 6, further comprising:
detecting a position parameter of the lawn mowing robot, the position parameter comprising at least one of: position signal strength and position coordinates; and
determining that the mapping trajectory of the lawn mowing robot has an error when the position parameter satisfies a set condition.

11. The mapping correction method according to claim 6, comprising:
determining, based on signal strength along the mapping trajectory, a correction reference point; and
prominently displaying the reference point on a display interface of the display device.

12. The mapping correction method according to claim 6, further comprising:
preserving the correct mapping trajectory and erasing other mapping trajectories.

13. A mapping correction device, performed by a lawn mowing robot, wherein the mapping correction device comprising: a receiving unit, a determining unit, and a mapping unit, wherein,
the receiving unit is configured to receive, in response to an error occurring in a mapping trajectory of the lawn mowing robot, a correction instruction
the determination unit is configured to determine a target correction point in the mapping trajectory while the lawn mowing robot is moving, the target correction point being located at a distance greater than a predetermined distance from a start point of the mapping trajectory; and
the mapping unit is configured to return to the target correction point, and continuing a mapping operation based on a correct mapping trajectory and the target correction point, the correct mapping trajectory being a portion of the mapping trajectory between the start point and the target correction point;
wherein the determination unit is further configured to:
generate, based on a current position point of the lawn mowing robot, at least one connecting line to the mapping trajectory, each connecting line forming an intersection point with the mapping trajectory;
determine, for each connecting line, a distance between the corresponding intersection point and the current position point to obtain at least one distance value; and
select a target distance value from the at least one distance value, acquiring the intersection point corresponding to the target distance value, and designating the intersection point as the target correction point.

14. The mapping correction device according to claim 13, wherein the at least one connecting line comprise a perpendicular line or a line extending between the current position point and any point on the mapping trajectory.

15. The mapping correction method according to claim 13, wherein the mapping unit is further configured to:
determine a trajectory path between the current position point and the target correction point;
detect a dwell time of the lawn mowing robot at positions along the trajectory path; and
when a dwell time at a position on the trajectory path exceeds a preset value, transmit a prompt message to a display device to prompt a user to manually control the lawn mowing robot to return to the target correction point, the position being any position point on the trajectory path.

16. The mapping correction device according to claim 13, the mapping unit is further configured to:
detect a position parameter of the lawn mowing robot, the position parameter comprising at least of: a position signal strength and a position coordinate; and
determine that the mapping trajectory of the lawn mowing robot has the error when the position parameters satisfy a predetermined condition.
